(19) United States
(12) Patent Application Publication
(10) Pub. No.: US 2015/0206093 A1
(43) Pub. Date: Jul. 23, 2015

(54) CROWD SOURCED DELIVERY ASSISTANCE

(71) Applicant: GOOGLE INC., Mountain View, CA (US)

(72) Inventors: Brandon Kyle Trew, San Francisco, CA (US); Thomas Mackenzie Fallows, San Francisco, CA (US); James Powell, Pittsburgh, PA (US); Michael Nathan Nonemacher, Pittsburgh, PA (US)

(73) Assignee: GOOGLE INC., Mountain View, CA (US)

(21) Appl. No.: 14/055,857

(22) Filed: Oct. 16, 2013

Related U.S. Application Data
(63) Continuation-in-part of application No. 13/953,736, filed on Jul. 29, 2013.
(60) Provisional application No. 61/773,132, filed on Mar. 5, 2013.
(60) Provisional application No. 61/676,838, filed on Jul. 27, 2012.

(51) Int. Cl. G06Q 10/08

(52) U.S. Cl. CPC G06Q 10/083

(57) ABSTRACT

Crowd sourced delivery assistance. Receiving a submission comprising a geolocation and at least one of an image and an annotation. The received submission associated with a submitting courier. Publishing the received submission via a communications network accessible by a plurality of courier devices. Receiving a selection of a published submission. The selection associated with one of the plurality of courier devices. Transmitting the selected submission to the selecting courier device for display. Crediting a courier score of the submitting courier.

### CROSS REFERENCE TO RELATED APPLICATIONS

This application is a continuation-in-part of U.S. patent application Ser. No. 13/953,736, filed Jul. 29, 2013 and entitled “Near-term Delivery Local Online Shopping,” which claims the benefit of both U.S. Provisional Patent Application No. 61/676,838, filed Jul. 27, 2012, entitled “Order Management,” and U.S. Provisional Patent Application No. 61/773,132, filed Mar. 5, 2013, entitled “Lifestyle Courier Scheduling.” The complete disclosure of each of the above-identified applications is hereby fully incorporated herein by reference.

### FIELD OF THE TECHNOLOGY

The disclosed technology relates to online shopping. Example embodiments relate to receiving and publishing delivery assistance submissions, providing selection of published submissions, transmitting selected submissions, and crediting submitting couriers.

### BACKGROUND

“Electronic commerce” and “e-commerce,” refer to buying and selling, and, in some instances, online delivery, of goods or services (hereinafter referred to as “products”) enabled at least in part by electronic systems such as the Internet. Specifically, “online retailing” can be used when referring to business-to-consumer (B2C) e-commerce. Most online retailing involves product selection, ordering, and payment via a web browser, then order fulfillment, and finally delivery by conventional delivery services. Typically, the consumer is willing to incur a short delay in fulfillment (often on the order of a day or two), and a delay in delivery.

Typical delivery times are 3-5 business days (or longer if free delivery is selected), with shorter delivery times available for a premium. Delivery options include downloading (for software products), direct shipping from the online retailer, drop shipping (by-passing the online retailer's location and shipping the product directly from a manufacturer or distributor), and printing out or will-call (used primarily for tickets).

If the typical fulfillment and delivery latency is acceptable, then the location of the merchant typically does not matter to the consumer if delivery costs are relatively low. But in circumstances where one or more of the merchant location and delivery speed matter to the consumer, local online shopping may be used.

“Local shopping” when used in online retailing, can refer to activities that include responding to an online product query with the identity of one or more local brick-and-mortar stores that offer the product. The response typically includes store location, product price, product features, and current stocking level at each store location. Often, the product can be ordered online, and picked up at a local brick-and mortar location within a matter of minutes or hours. Or the user can visit the brick-and-mortar location to buy the product offline after locating the local merchant offering the product and confirming that the product is in stock at that location.

If the consumer wants delivery of a locally stocked product within a short time frame, for example the same day as ordering, then the consumer is typically limited to delivery from a single business (for example pizza delivery and dry cleaning pick up and delivery), or limited to delivery by a product category courier (for example, a multi-restaurant delivery service), or limited to delivery by a general courier, or limited to the use of errand labor auction service (for example, TaskRabbit™ online errand labor auction service).

### BRIEF DESCRIPTION OF THE DRAWINGS

FIG. 1 is a diagram depicting a communications and processing architecture for courier scheduling of the present technology, in accordance with certain example embodiments.

FIG. 2 is a diagram depicting methods for item swap and order transfer in a near-term delivery local online shopping system in accordance with certain example embodiments of the present technology.

FIG. 3 is a diagram depicting a portion of a web page accessible via a world wide web executing on an Internet-enabled courier device as an example of a geographically represented publication of a submission in accordance with certain example embodiments of the present technology.

FIG. 4 is a diagram depicting methods for item swap and order transfer in a near-term delivery local online shopping system in accordance with certain example embodiments of the present technology.

FIG. 5 is a diagram depicting a portion of a web page accessible via a world wide web executing on an Internet-enabled courier device as an example of a geographically represented publication of a submission in accordance with certain example embodiments of the present technology.

FIG. 6 is a diagram depicting methods for item swap and order transfer in a near-term delivery local online shopping system in accordance with certain example embodiments of the present technology.

FIG. 7 is a diagram depicting methods for item swap and order transfer in a near-term delivery local online shopping system in accordance with certain example embodiments of the present technology.

FIG. 8 is a block diagram depicting a computing machine and a module, in accordance with certain example embodiments.

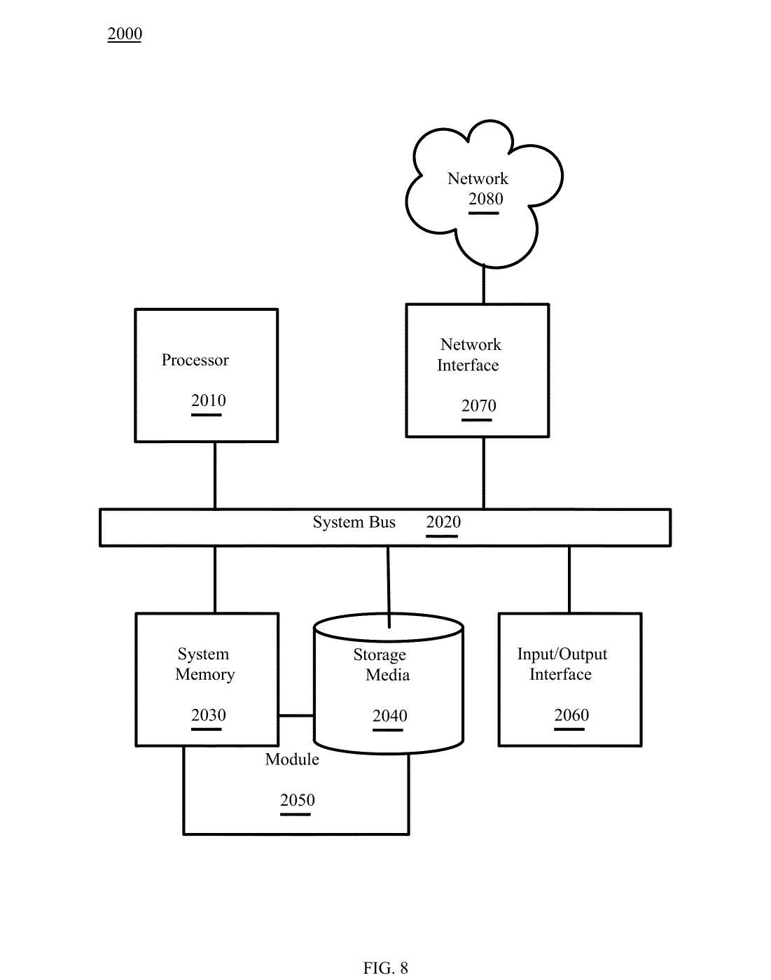

### SUMMARY

The technology described herein includes computer implemented methods, computer program products, and systems for crowd sourced delivery assistance in a near-term local delivery on line shopping system. In embodiments of the technology, a submission comprising a geolocation and at least one of an image and an annotation is received. The received submission is associated with a submitting courier. The received submission is published via a communications network accessible by a plurality of courier devices. A selection of a published submission is received. The selection is associated with one of the plurality of courier devices. The selected submission is transmitted to the selecting courier device for display. A courier score of the submitting courier is credited.

In some embodiments, publishing the received submission comprises publishing the received submission using a geographic representation. In some embodiments, the received selection is associated with one of a plurality of courier devices by having a geolocation in common with a geolocation of a route assigned to a courier associated with the one of a plurality of courier devices. In some embodiments, receiving a selection comprises receiving at least one of a geolocation or geolocation name for which a submission has been published. In some embodiments, a courier score of the submitting courier is credited upon receiving a submission associated with the submitting courier. In some embodiments, a courier score of the submitting courier is credited upon receiving a selection of a submission associated with the submitting courier.

Some embodiments further include receiving a review of the transmitted submission from a courier device to which the submission was transmitted. In such embodiments a courier score of the submitting courier is credited as function of the received review.

These and other aspects, objects, features, and advantages of the example embodiments will become apparent to those having ordinary skill in the art upon consideration of the following detailed description of illustrated example embodiments.

### DETAILED DESCRIPTION

### Overview

Providing local online shopping with near-term delivery, especially using independent individual couriers, presents challenges not met by single-business delivery, product category couriers, general couriers, or errand labor auction services. Among those challenges is leveraging the information on routes and locations gained by previous couriers for the benefit of subsequent couriers. This is an especially acute challenge in a near-term local delivery online shopping system using independent couriers who might not have a common company or otherwise might not value institutional knowledge of routes and pick up/drop off locations.

Embodiments of the present technology can receive a submission of a geolocation and at least one of an image and an annotation. The received submission can be associated with a submitting courier. For example, a courier can take a photo of an approach to an inventory site that has low-hanging utility wires, and submit the photo, along with a geolocation and a note “Watch for low hanging utility wires in the west approach to the loading dock at Soup-To-Nuts Main Street location.”

The received submission can be published via a communications network accessible by a plurality of courier devices 124. For example, the received submission can be published via a web site accessible via tablet computers used by couriers over mobile data networks.

Selection of a published submission can be received from one of the courier computing 124. For example, when a courier is assigned a route, the assignment can constitute a selection of submissions at each pick up and drop off location on the route. Additionally, a courier can use a courier device 124 to select a submission, such as via a map of submissions displayed on a web page accessed by the courier using a courier device 124. The selected submission can be transmitted to the courier device 124.

A courier score of the submitting courier can be credited. Courier score can be used in scheduling couriers and assigning scheduled couriers to routes. Courier score can be primarily determined by objective and subjective criteria regarding shift performance and performance of routes by the courier—using courier score credits, such as credits for submitting geo-tagged information such as described herein, for having that information selected by another courier, and based on reviews given to the submitted information.

Turning now to the drawings, in which like numerals represent like (but not necessarily identical) elements throughout the figures, example embodiments of the present technology are described in detail.

### Example System Architectures

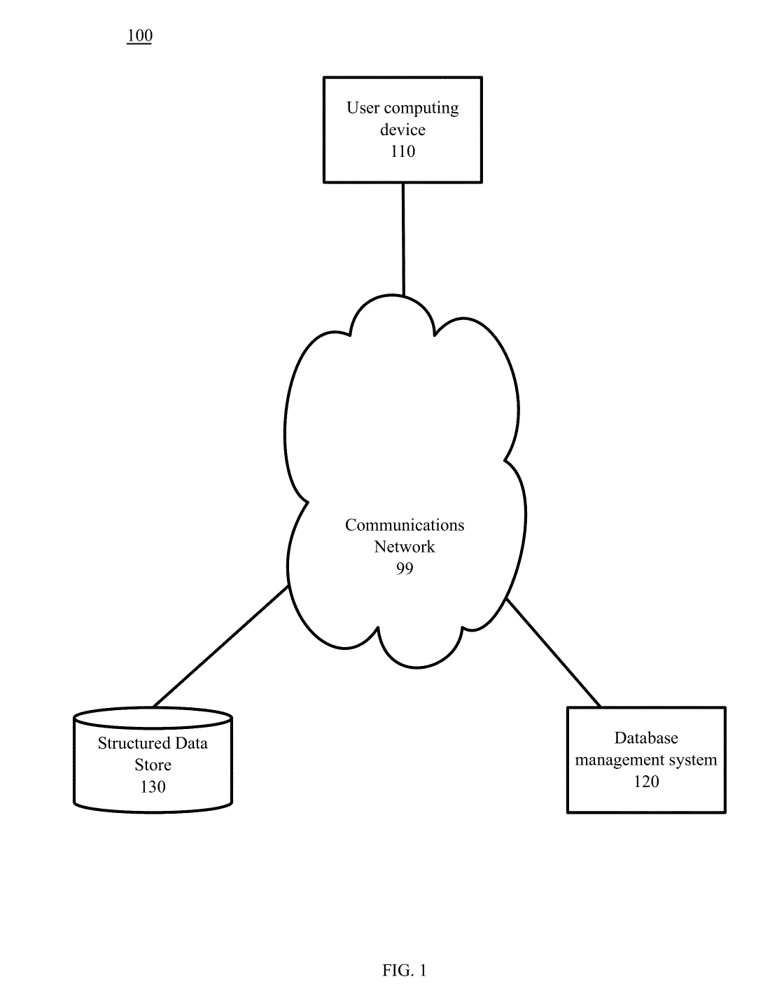

Referring to FIG. 1, an example architecture for near-term delivery local online shopping 100 is illustrated. While each server, system, and device shown in the architecture is represented by one instance of the server, system, or device, multiple instances of each can be used. Further, while certain aspects of operation of the present technology are presented in examples related to FIG. 1 to facilitate enablement of the claimed invention, additional features of the present technology, also facilitating enablement of the claimed invention, are disclosed elsewhere herein.

As depicted in FIG. 1, the architecture 100 includes network devices 110, 122, 130, 140, 150, 160, 170, 124, 180, and 190; each of which may be configured to communicate with one another via communications network 99. In some embodiments, a user associated with a device must install an application and/or make a feature selection to obtain the benefits of the technology described herein.

Network 99 includes one or more wired or wireless telecommunications means by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 99. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, a merchant may operate network devices 110 and 130. A consumer may operate network device 122. A near-term delivery local shopping operator may operate devices 140, 150, 160, 170, 180, and 190. A courier may operate device 124.

The network connections illustrated are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, consumer device 122 may be embodied as a mobile phone or handheld computer may not include all the components described above.

In such an architecture 100, a merchant online store server 110 may be responsive to product information requests from a consumer device 122. For example, a consumer may use a consumer device 122 such as a tablet, a smartphone, or a personal computer to search for a specific camera on a retail merchant's online shopping server via either a web browser or via a native application running on the consumer device 122, in each case communicating with the merchant online store server 110 over network 99.

Additionally, a merchant may use a merchant system 130 to update an inventory data server 140 of the present technology with current inventory levels across one or more inventory sites associated with a given local zone. For example, a retail merchant may provide current inventory information from the point-of-sale (POS) system or inventory system of the merchant regarding quantities of the camera available in each of a plurality of the retail merchant's stores within a given set of ZIP codes including the current ZIP code of the consumer device. In some embodiments, a merchant may use a computing device of the merchant system 130 to capture an image of a product, or at least an image of a unique product identifier, such as a Universal Product Code (UPS) bar code. The inventory data server 140 can use product image recognition technology to relate the image to a product having information in a master catalog accessible to the inventory data server 140. Upon identifying the quantity of the product in stock at the particular merchant inventory site, the product can be made available to consumers in embodiments of the present technology.

As with the merchant online store server 110, a local shopping server 150 can be responsive to product information requests from the consumer device 122. For example, the consumer may use a consumer device 122 such as a tablet, a smartphone, or a personal computer to search for the camera on the online local shopping server 150 via either a web browser or a native application. The local shopping server 150 can respond with the availability of inventory in a given local zone. For example, a local shopping web site can respond to a request from the Internet browser of a consumer's tablet computer based on the local shopping operator's stock of the camera at inventory sites associated with the local zone, and based on current inventory information provided by one or more merchants having an inventory site (whether a retail store or a warehouse) associated with the local zone. For example, the local shopping server 150 can respond that the camera is available from three (3) inventory sites within the local zone—one (1) site being a merchant inventory site, two (2) sites being inventory sites of the local shopping operator.

A consumer may select a product using the consumer device 122, through either the merchant online store server 110 or the local shopping server 150 of the present technology. The order can be completed for near-term local delivery in conjunction with an order management system 160 of the present technology. For example, if the consumer used a web browser on a consumer device 122 to select the camera from the merchant's web site, a web widget 112 can provide functionality to connect the consumer device 122 with the order management system 160 to complete the order for local same day delivery. As another example, a browser extension installed on the consumer device 122 can be used to connect the consumer device 122 to the order management system 160 to complete the order for local same day delivery.

Completing the order can include confirming the availability of the product for specific delivery conditions such as time window and location. For example, the order management system 160 may determine, using the inventory data server 140, that while the camera is in stock at the three (3) inventory sites within the local zone, the camera is available for delivery within one hour from only one (1) of the inventory sites of the local shopping operator.

As another example, consider that the consumer may have interacted with a merchant online store server 110 and selected the camera in stock at the merchant's inventory site in the local zone. In that case, upon invoking the widget for interaction with the order management system 160 and specifying one-hour delivery, the order management system can determine that the camera, while in stock at the merchant's inventory site in the local zone (a retail store), cannot be delivered within one hour. The order management system 160 can then identify the one camera in its inventory that is available for delivery within one hour, and offer that camera as an alternative. While the continuing example describes an order for a camera, in embodiments of the present technology an order can include more than one product, and each product can be sourced from a different inventory site.

As part of completing the order, the order management server 160 can interact with a shipping system 170, to determine, for example, available courier resources that fit the delivery conditions specified by the consumer via the consumer device 122. As part of completing the order, the order management system 160 can interact with an inventory site system 180, to determine, for example, available inventory site resources to pick, checkout, pack, and otherwise prepare the order for pickup at the inventory site by an assigned courier.

The shipping system 170 can forecast the need for couriers, receive information regarding the cost, schedule, and capabilities of individual couriers, and schedule couriers for shifts based on the forecast and courier cost/schedule/performance information. For example, the shipping system 170 can use historical data to forecast order volume, and can use historical courier performance to forecast the courier capacity needed to meet the forecasted order volume. Cost information from couriers, each of whom can be an independent operator and have its own rate schedule, can be received as a function of a plurality of factors including zone location, time of day, type of cargo, etc. Information regarding capabilities of individual couriers can include characteristics such a dimension of maximum parcel that can be couriered, and whether the courier can transport products requiring refrigeration. Schedule information from couriers can include time frames available for active route assignment, time frame available for overflow or on-call route assignments, conditions under which a courier is available for emergency route assignments outside of active and on-call times, and time frames not available for assignment under any conditions.

Upon receiving a completed order for one or more products from the order management system 160, the shipping system 170 can determine routes and assign the determined routes to scheduled couriers. Each route can include the pickup and dropoff of one or more parcels containing products of an order. A route assignment can be communicated to a courier by the shipping system 170 via a courier device 124. For example, the pickup and dropoff of the camera can be assigned to a courier having an existing route passing the inventory site specified in the order for the camera.

While there may be several scheduled couriers that can be assigned to the route, some embodiments of the technology can use courier characteristics in choosing from among scheduled couriers. Courier characteristics can cover performance, cost, and status of each courier, and can include both objective information (such as percentage of on-time deliveries) and subjective information (such as ratings and reviews of couriers by stakeholders including consumers, merchants, and near-term local delivery system operator).

Upon completing an order, either the order management system 160 or the shipping system 170 can interact with the inventory site system 180 to assign and prioritize picking, checkout, packing, and other preparation for pickup by a courier for each product in the order. For example, the order management system 160 may have assigned the ordered camera to the single inventory site from which the camera can be delivered to the delivery location within an hour.

The inventory site system 180 can participate in prioritizing the picking, checkout, and packing of the products assigned to the inventory site, and can facilitate the efficiency of the process through both server applications, and product picker applications running on devices (not explicitly shown in FIG. 1) used by personnel to pick products. In some embodiments one or more of product picking, checkout, and packing can be automated. The inventory site system 180 can interface with the order management system 160 and the inventory data server to update inventory information for each inventory site. For example, in a merchant retail location that is an inventory site, a picker can use a computing device that incorporates a bar code reader or image recognition capabilities to log products collected from the inventory site for checkout.

In particular, inventory site system 180 can facilitate the assembly of checkout-friendly collections of product identifiers so that checkout on a picked order goes quicker. For example, at a merchant inventory site without a highly integrated checkout system (such as an existing brick-and-mortar retail store), the inventory site system 180 can facilitate collecting Universal Product Code (UPC) barcodes that can be printed and scanned by conventional checkout scanners without having to physically scan each product at the checkout. At inventory sites with slightly more automated checkout systems, a list of UPC numbers collected during picking can be transmitted to the checkout system by an element of the inventory site system 180 for processing at checkout. This approach can lower the cost of integrating a traditional brick-and-mortar merchant retail location into a near-term delivery local shopping system.

In some embodiments one or more of inventory site system 180, order management system 160, shipping system 170, local shopping server 150 (or merchant online store server 110), and consumer device 122 can interact to authorize and execute an product swap or an inventory site transfer. For example, when an ordered product is determined to be out of stock by a picker, based on permissions obtained from the consumer via the consumer device the product can be swapped for an acceptable equivalent available at the same inventory site, or the order for the product can be transferred to another inventory site. In either event, the technology can determine if rescheduling or rerouting is required, and can perform any required rescheduling and rerouting.

The order management system 160, shipping system 170, courier devices 124, and inventory site system 180 can interact to obtain information regarding a delivery status of an order (including the delivery status of individual products in the order). For example, a courier device 124 in the possession of a courier can determine and provide geolocation information, and information on the identity of parcels, orders, and products that have been picked up by the courier. The shipping system 170 can receive such information, and estimate the time of arrival of the package based on inputs such as: route (including parcel pick ups and drop offs on the route); traffic, weather, and events in the local zone; and performance history of the courier. Such information can be used to respond to a delivery status query from the consumer device 122 to any one of the merchant online store 110, the local shopping server 150, the order management system 160, the shipping system 170, or the inventory site system 180—though typically such queries can be forwarded to the shipping system 170.

In some embodiments, interaction between the shipping system 170 and the courier devices 124 allows the shipping system to re-plan routes dynamically. For example, pickup of the camera from the inventory site, and dropoff of the camera at the delivery destination can be added to an existing route.

In some embodiments, courier devices 124 can obtain geolocation-oriented images of route features, such as the approach to a pickup or dropoff point, and can receive annotations of such images, for example in the form of metadata or tags. The tagged geolocation-oriented images can be made available to other couriers to facilitate efficient route execution. Courier score points can be awarded to couriers who add useful information to the collection of tagged geolocation-oriented images. For example, several different couriers can contribute tag information to an image, submitted by a first courier, of the overhead wires partially obstructing an entrance to the loading dock at a particular inventory site. Subsequent couriers having that inventory site as a stop on an assigned route can either consult the data store of tagged geolocation-oriented images using a courier device 124, or a series of applicable images and metadata can be made available to a courier via the courier device 124 when a route assigned to the courier includes the inventory site.

A system control server 190 can be used so that system operators may receive signals from each other device, server, and system described herein, and edit or direct the operation thereof in accordance with the policies of the technology operator.

### Example Methods

The example methods illustrated in the following figures are described hereinafter with respect to the components of the example operating environment and example architecture described elsewhere herein. The example methods may also be performed with other systems and in other environments.

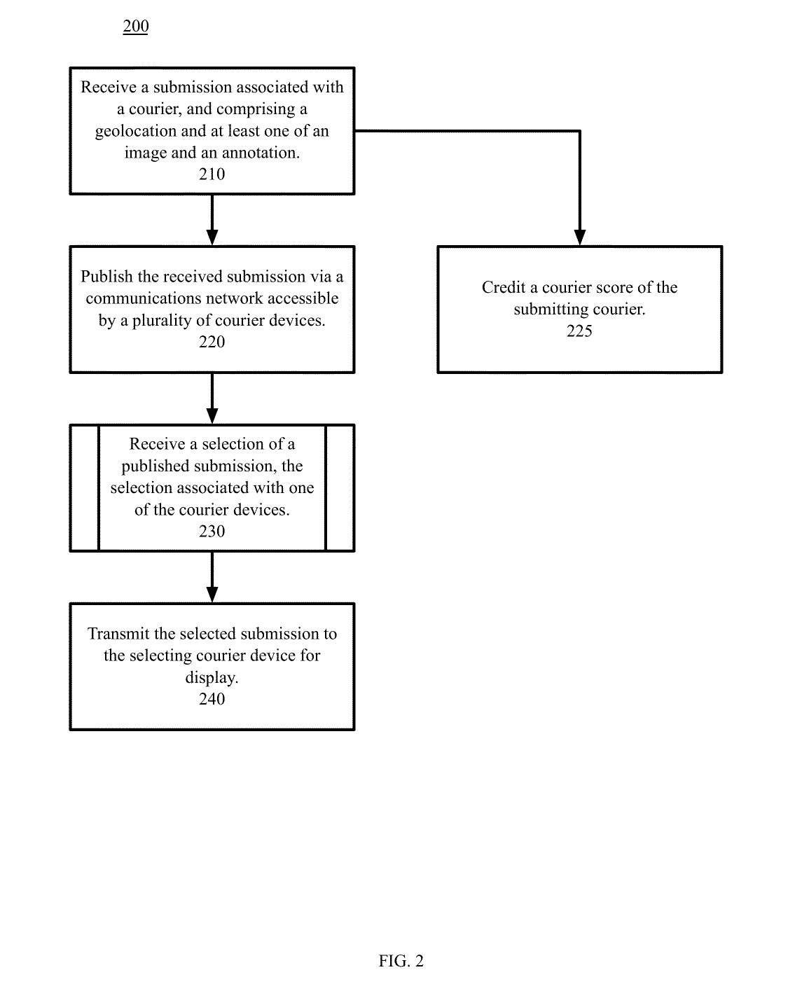

Referring to FIG. 2, and continuing to refer to FIG. 1 for context, example methods 200 for crowd sourced delivery assistance in accordance with embodiments of the present technology are illustrated. In such embodiments, a submission comprising a geolocation and at least one of an image and an annotation is received—Block 210. The received submission is associated with a submitting courier. Consider as a continuing example that the submissions of TABLE 1 are received, each with a photo of the receiving dock area at the rear of the Empire State Building. Other formats, including formats comprising additional metadata, can be used.

TABLE 1

| | GEO- | | | |
|---|---|---|---|---|
| INDEX | LOCATION | PLACE | ANNO- | |
| # | (UTM) | NAME | TATION | METADATA |
| 1 | 18T 585632 | | Woah! | Date: 2012 04 17 |
| | 4511326 | | | Submitted by: |
| | | | | Driver 3 |
| 2 | 18T 585632 | Empire State | Low wire | Date: 2013 01 15 |
| | 4511326 | Building (rear | (about 10′) | Submitted by: |
| | | loading dock) | | Driver 2 |
| 3 | | Empire State | Cables in | Date: 2013 05 20 |
| | | Building | the way. | Submitted by: |
| | | | | Driver1 |

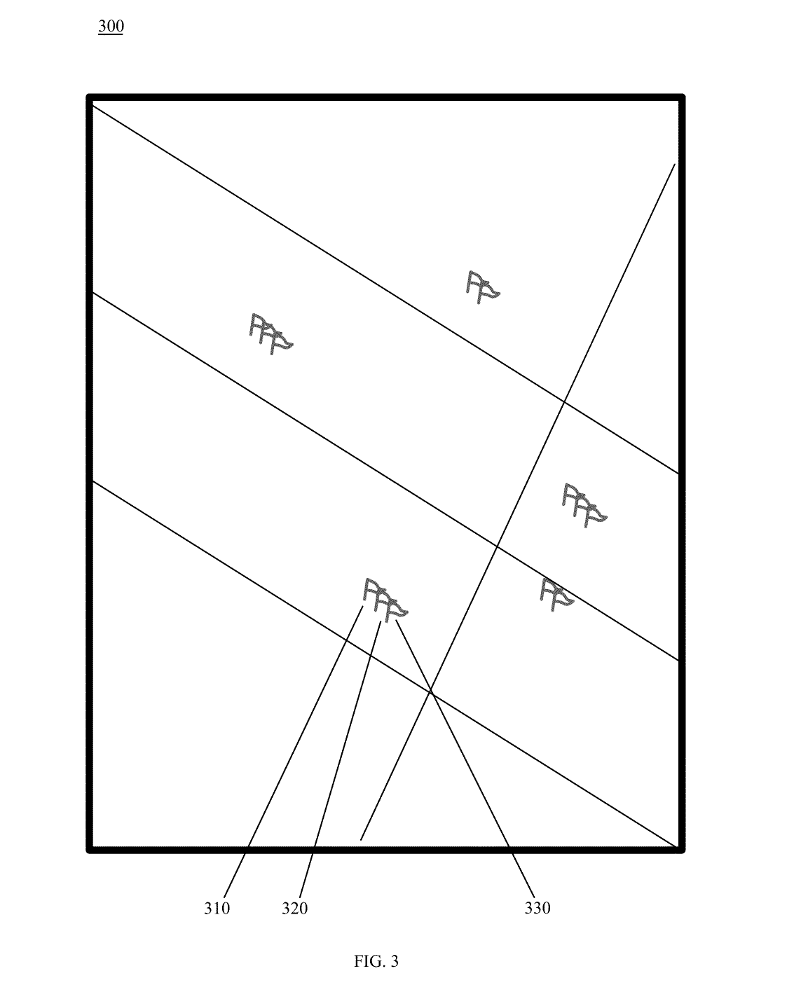

Each received submission can be published via a communications network accessible by a plurality of courier devices—Block 220. In reference to the continuing example, while submission #3 is not geo-tagged, the place name included as part of the submission is sufficient to associate the submission with a geolocation, for example, through use of a gazetteer. Referring to FIG. 3, and continuing to refer to prior figures for context, a portion 300 of a web page accessible via a world wide web executing on an Internet-enabled courier device 124 is shown as an example of a geographically represented publication of thirteen (13) submissions, each indicated by a flag such as flags 310 (corresponding to submission #1), 320 (corresponding to submission #2), and 330 (corresponding to submission #3), consistent with the continuing example.

Embodiments of the present technology receive a selection of a published submission—Block 230. In some embodiments, the selection is associated with one of the plurality of courier devices 124. The selected submission is sent to the selecting courier device 124 for display—Block 240.

In the continuing example, a courier interested in making a delivery to the Empire State Building could access the published submissions displayed in an interactive geographic presentation as in FIG. 3 via a native application running on the courier's courier device 124 and communicating with a shipping system 170 of the present technology. The courier can select flag 310, corresponding to submission #1, see the photo associated with the submission (which shows a wire across the receiving dock at on the ground), read the annotation “Woah!,” and note the date. The courier can then select flag 330, corresponding to submission #3, see the photo associated with the submission (which shows a wire across the receiving dock well off the ground), read the annotation “Cables in the way,” and note a later date than submission #1. Though both submissions indicate a potential impediment to approaching the receiving dock at this location, and submission #3 indicates that the wire has been raised off the ground, the courier is using an eight (8) foot high delivery vehicle and can't be sure that there is sufficient clearance to the receiving dock. The courier can use courier device 124 to select flag 320 to display submission #2. Upon reading the annotation of submission #2, the courier no has information that the wire across the receiving dock is at ten (10) feet off the ground, providing sufficient clearance for the courier's eight (8) foot delivery vehicle.

A courier score of the submitting courier is credited for contributing to the crowd sourced delivery assistance at any point after receiving the submission—Block 225. For example, upon submission, a submitting courier can receive a credit to a courier score used in one or more of scheduling individual couriers for shifts, assigning routes to scheduled couriers, awarding compensation bonuses to couriers, and recognizing courier community contributions, among others. Co-pending U.S. Provisional Patent Application No. 61/773,132, filed Mar. 5, 2013, entitled “Lifestyle Courier Scheduling,” and U.S. patent application Ser. No. 14/039,132, filed Sep. 27, 2013, entitled “Courier Scheduling,” provide examples of the use of courier scores.

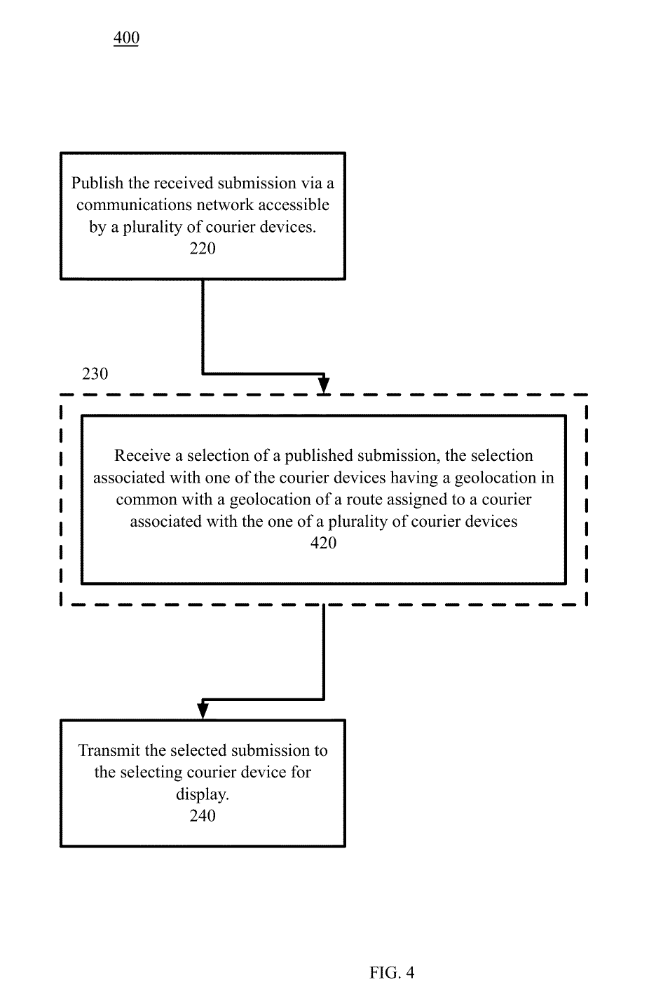

Considering FIG. 4, and continuing to refer to prior figures for context, example methods 200 for crowd sourced delivery assistance in accordance with embodiments of the present technology are illustrated. In such methods, blocks 220 and 240 can be performed as described elsewhere herein, for example as described above in conjunction with blocks 210 and 225. In such embodiments, selection from among available submissions is determined by identifying those submissions having a geolocation in common with one or more features of a route assigned to a courier associated with the selecting courier device 124—Block 420. For example, upon being assigned a route via a courier device 124, the courier associated with the courier device 124 selects to have submissions related to the pick up and drop off points on the route displayed.

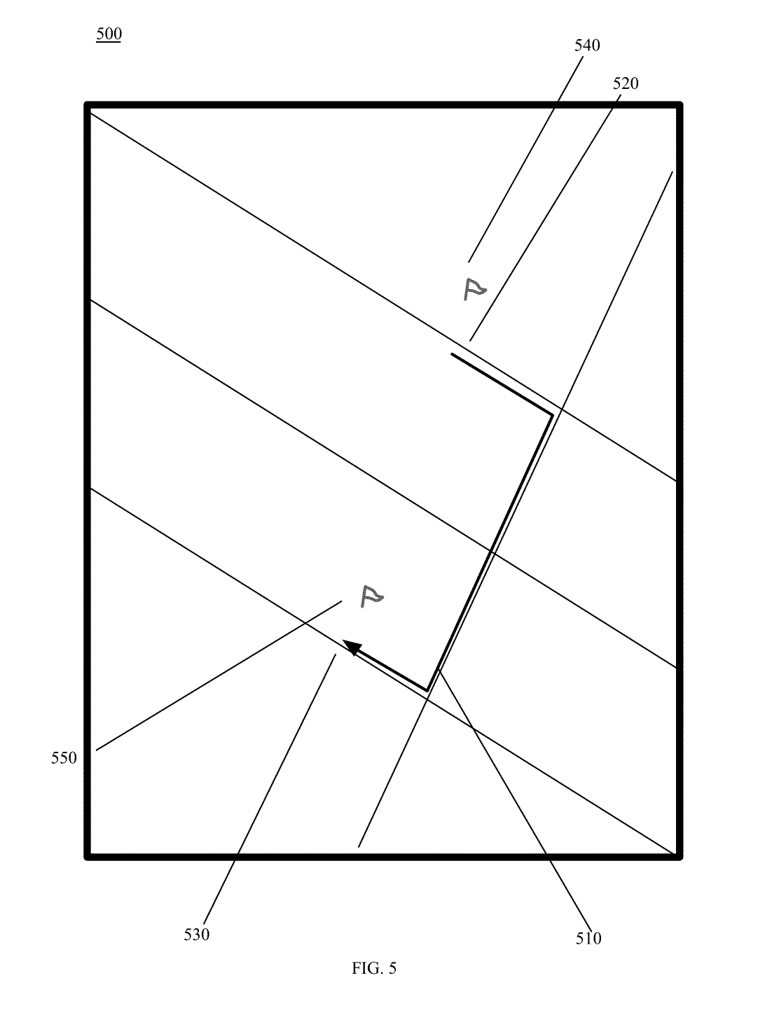

Referring to FIG. 5, and continuing to refer to prior figures for context, a portion 500 of a web page accessible via a world wide web executing on an Internet-enabled courier device 124 is shown as an example of a the method illustrated in FIG. 4. In such an embodiment, a courier was assigned route 510 with a pick up at location 520 and a drop off at location 530. Submissions 540 and 550 are automatically selected by some embodiments of the technology as corresponding to points along the route. In some embodiments, submissions for intermediate points along the route are selected and displayed in this form. In some embodiments, the selected submissions are directly displayed. In the example of FIG. 5, submission 550 corresponds to submission #2 of TABLE 1.

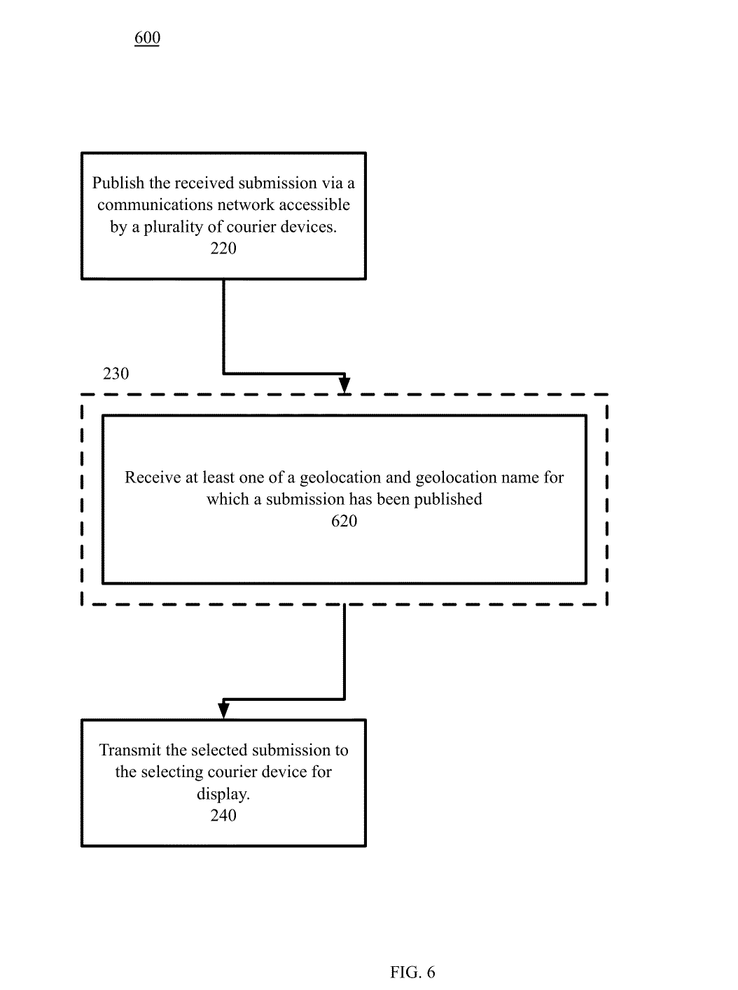

Referring to FIG. 6, and continuing to refer to prior figures for context, example methods 200 for crowd sourced delivery assistance in accordance with embodiments of the present technology are illustrated. In such methods, blocks 220 and 240 can be performed as described elsewhere herein, for example as described above in conjunction with blocks 210 and 225. In such embodiments, selection from among available submissions is determined entering or selecting a geolocation or geolocation name with the selecting courier device 124—Block 620. For example a courier associated with the courier device 124 enters a geolocation, for example a geolocation of the courier device 124 at the Empire State Building as detected by the device and automatically entered, or enters a name, for example “Empire State Building.” In either case, one or more submissions related to the location of the Empire State Building are presented for individual selection, or are directly displayed on the courier device 124.

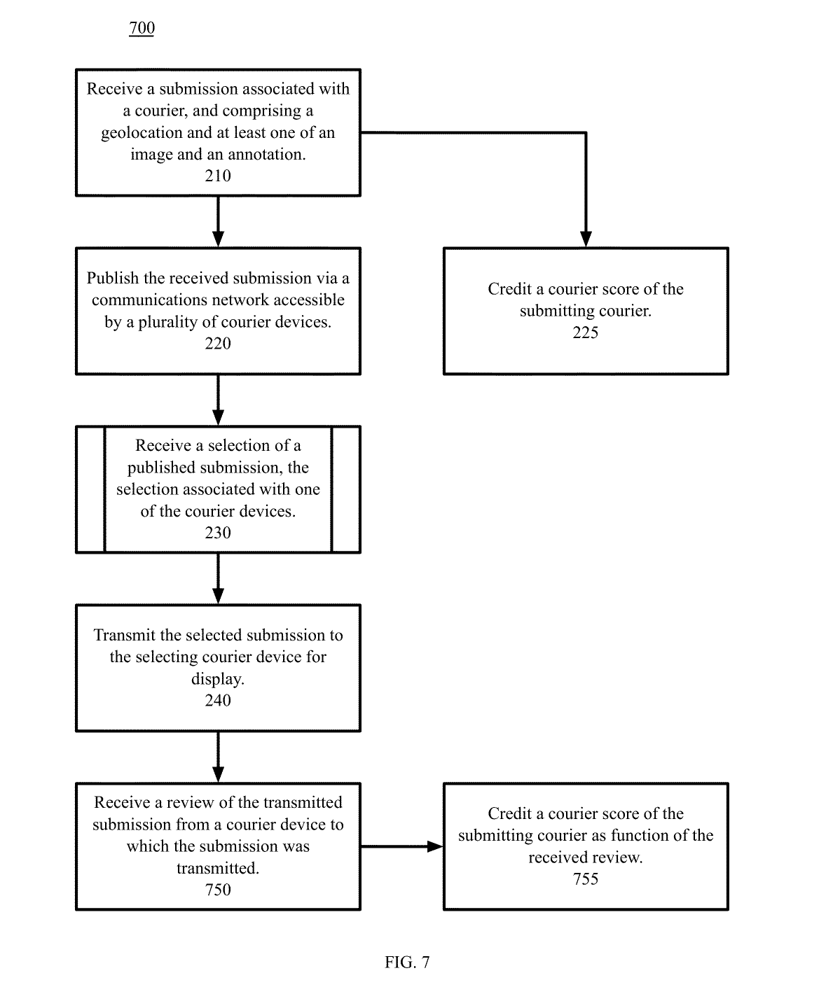

Referring to FIG. 7, and continuing to refer to prior figures for context, example methods 700 for crowd sourced delivery assistance in accordance with embodiments of the present technology are illustrated. In such methods, blocks 210, 220, 225, 230, and 240 can be performed as described elsewhere herein. In such embodiments, a review of the transmitted submission is received from a courier device to which the submission was transmitted—Block 750. Referring to the continuing example, the courier rates submission #2 as “5” on a scale from 0-5, submission #3 as “3,” and submission #1 as “2.” The courier score for the submitting courier for each submission is credited as a function of the rating—Block 755. In the continuing example, the courier score for courier Driver 2 is credited more than the courier score for courier Driver 1, which is credited more then the courier score for courier Driver 3.

### Other Example Embodiments

FIG. 7 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device, for example, a system on chip (SOC), system on package (SOP), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures. For example, in some embodiments, the technology can organize submissions as a wiki, in which case any given location can have a single collaboratively edited entry, and courier scores can be credited in a fashion used to accredit contributors to other wikis. In some embodiments, the data store of submissions is curated, for example to remove obsolete, erroneous, or otherwise inappropriate submissions. In some embodiments, a submission is recommended from among the current submissions for a location based on one or more figures of merit such as a courier score of the submitting courier and a rating of the submission.

1. A computer-implemented method for delivery assistance comprising:
receiving, by one or more computing devices, a plurality of submissions, each submission comprising a geolocation and at least one of an image and an annotation, each received submission associated with a submitting courier in a same day delivery system;
receiving, by the one or more computing devices, a route of an assigned courier;
transmitting, by the one or more computing devices, each received submission having a geolocation in common with either a pick up point or a drop off point of the route to a courier device of the assigned courier for display;
receiving, by the one or more computing devices, a review of a transmitted submission from the courier device to which the submission was transmitted; and
crediting, by the one or more computing devices, a courier score of the submitting courier as a function of the received review.

2. The method of claim 1, wherein publishing the received submission comprises publishing the received submission using a geographic representation.

3. (canceled)

4. The method of claim 1, wherein receiving a selection comprises receiving at least one of a geolocation or geolocation name for which a submission has been published.

5. The method of claim 1, wherein a courier score of the submitting courier is credited upon receiving a submission associated with the submitting courier.

6. The method of claim 1, wherein a courier score of the submitting courier is credited upon receiving a selection of a submission associated with the submitting courier.

7. (canceled)

8. A computer program product comprising:
a non-transitory computer-readable storage device having computer-executable program instructions embodied thereon that when executed by a computer cause the computer to implement crowd sourced assistance to package delivery, the computer executable program instructions comprising:
computer-executable program instructions to receive a plurality of submissions, each submission comprising a geolocation and at least one of an image and an annotation, each received submission associated with a submitting courier in a same day delivery system;
computer executable program instructions to receive a route of an assigned courier;
computer-executable program instructions to transmit each received submission having a geolocation in common with either a pick up point or a drop off point of the route to a courier device of the assigned courier for display;
computer-executable program instructions to receive a review of a transmitted submission from the courier device to which the submission was transmitted; and
computer-executable program instructions to credit a courier score of the submitting courier as a function of the received review.

9. The computer program product of claim 8, wherein publishing the received submission comprises publishing the received submission using a geographic representation.

10. (canceled)

11. The computer program product of claim 8, wherein receiving a selection comprises receiving at least one of a geolocation or geolocation name for which a submission has been published.

12. The computer program product of claim 8, wherein a courier score of the submitting courier is credited upon receiving a submission associated with the submitting courier.

13. The computer program product of claim 8, wherein a courier score of the submitting courier is credited upon receiving a selection of a submission associated with the submitting courier.

14. (canceled)

15. A system to implement crowd sourced assistance to package delivery, the system comprising:
a storage device; and
a processor communicatively coupled to the storage device, wherein the processor executes application code instructions that are stored in the storage device and that cause the system to:
receive a plurality of submissions, each submission comprising a geolocation and at least one of an image and an annotation, the received submission associated with a submitting courier in a same day delivery system;
receive a route of an assigned courier;
transmit each received submission having a geolocation in common with either a pick up point or a drop off point of the route to a courier device of the assigned courier for display;
receive a review of a transmitted submission from the courier device to which the submission was transmitted; and
credit a courier score of the submitting courier as a function of the received review.

16. The system of claim 15, wherein publishing the received submission comprises publishing the received submission using a geographic representation.

17. (canceled)

18. The system of claim 15, wherein receiving a selection comprises receiving at least one of a geolocation or geolocation name for which a submission has been published.

19. The system of claim 15, wherein a courier score of the submitting courier is credited upon receiving a submission associated with the submitting courier.

20. The system of claim 15, wherein a courier score of the submitting courier is credited upon receiving a selection of a submission associated with the submitting courier.

21. (canceled)
